(19) United States
(12) Patent Application Publication
(10) Pub. No.: US 2026/0239026 A1
(43) Pub. Date: Aug. 13, 2026

(54) ENDPOINT AUTOMATED CARRIER SELECTION

(71) Applicant: ITRON, INC., Liberty Lake, WA (US)

(72) Inventors: Christopher Lloyd OSTERLOH, Waseca, WI (US); Matthew ROCKEY, Fishers, IN (US); Karen Sue LIVINGSTON, Spokane, WA (US)

(21) Appl. No.: 19/050,400

(22) Filed: Feb. 11, 2025

(51) Int. Cl. H04W 24/02; H04W 24/08; H04W 24/10; H04W 48/18

(52) U.S. Cl. CPC H04W 24/02; H04W 24/08; H04W 24/10; H04W 48/18

(57) ABSTRACT

In various embodiments, a method comprises acquiring, by a connectivity management service executing on an endpoint device, performance metrics for a plurality of network sectors, where the performance metrics include at least one of a latency, a capacity, or packet reliability, selecting, by the connectivity management service and based at least on the performance metrics and additional performance metrics, a first network sector of the plurality of network sectors, and causing, by the connectivity management service, the endpoint device to connect to the first network sector.

### BACKGROUND

### Field of the Various Embodiments

The various embodiments relate generally to communications networks, and more specifically, to endpoint automated carrier selection.

### Description of the Related Art

Many enterprises can manage a large number of remote devices. For example, enterprises that control and/or monitor large infrastructure systems (e.g., power, water, traffic control, and the like) can include many thousands of devices (e.g., valves, metering devices, controllers, and the like). Generally, such devices report metrology data to and/or receive commands from one or more endpoint infrastructure management systems, which are tasked with coordinating the operation of the devices. Devices are often deployed in the field so that they communicate with endpoint infrastructure management systems over different networks that are operated by different network providers. These different networks can provide connectivity using different towers, different transport protocols, security requirements, and/or the like. As a result, connectivity, outages, speed, latency, and other network parameters can differ from network to network and thus differ from device to device.

### BRIEF DESCRIPTION OF THE DRAWINGS

So that the manner in which the features of the various embodiments can be understood in detail, a particular description of the inventive concepts may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual diagram of a networked environment for a connectivity management service, according to various embodiments;

FIG. 2 illustrates a more detailed view of an endpoint device of FIG. 1, according to various embodiments;

FIG. 3 illustrates an example of a networked environment that includes multiple carrier networks and the endpoint device of FIG. 1, according to various embodiments;

FIG. 4 illustrates another example of the connectivity management service of FIG. 1 selecting a sector for connection based on performance data for a plurality of sectors, according to various embodiments; and

FIG. 5 illustrates a flow diagram of method steps for the multi-carrier connectivity management service to select a network based on network performance data, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Many enterprises deploy large numbers of endpoint devices that are generally stationary, such as power meters, water meters, street light controllers, traffic controllers, and the like, as well as back-office management systems that monitor and/or control the endpoint devices. To deploy meters and other endpoint devices over a large geographic area, various carrier networks operated by different network providers under different access conditions are utilized. In many cases, the endpoint devices can connect to different carrier networks. For example, an endpoint device can include a single subscriber identity module (SIM) having multiple carrier profiles that enable communications via one or more of the different carrier networks.

Carrier networks can provide coverage that is separated into a number of sectors. Each sector provides connectivity to managed endpoint devices, as well as other devices from other users. A sector can become overloaded based on enterprise usage, but also as a result of other activity (e.g., other enterprises and users) in the sector, network errors, among other factors. Different carrier networks can provide connectivity using different towers, transport protocols, security requirements, and the like. As a result, connectivity, outages, speed, latency, and other carrier network parameters can differ from network to network and sector to sector within the same network. While the enterprise can use the same set of carrier networks for all endpoint devices, different multi-carrier SIMs (and endpoint devices) can alternatively enable connectivity using a SIM-specific set of carrier networks. As the deployment integrates additional endpoint devices, additional carrier networks are often utilized. Accordingly, a given enterprise is tasked with managing connectivity of a large network of endpoint devices deployed across a heterogeneous network served by multiple different carrier networks.

Enterprises often desire to use a particular carrier based on connectivity, costs, and other considerations, such as reliability, capacity, congestion, and the like. For example, a given endpoint device can experience degraded connectivity with a sector of the particular carrier though, due to factors such as the location of the endpoint device (e.g., the endpoint device experiencing high latency due to physical obstructions in the environment) and the capacity of the sector. Though the enterprise managing the endpoint device can desire that the sector change one or more operating parameters, the enterprise cannot easily change the configuration of the sector. Instead, the enterprise needs to request that the carrier network make changes to alter the network performance, and the carrier network manually changes the operation of the network to affect the operating parameters of one or more sectors.

Further, a typical cellular modem within an endpoint device does not select a sector for connection based on considerations like reliability or capacity. Instead, the typical endpoint device selects the sector for connection based on default connection criteria that is generally based on simple signal strength. Consequently, the typical endpoint device may remain connected to a sector that has degraded performance or may experience degraded connectivity without an efficient way to switch to another sector. An endpoint device that attempts to connect to a sector with lower connectivity performance metrics uses additional energy due to the multiple attempts to establish connections and/or to complete data transfers, using more capacity of a given sector than other endpoint devices with better connectivity.

To address these deficiencies, a connectivity management service executing on the endpoint device manages the connection of the endpoint device to one or more sectors to ensure reliable connection using one of the available carriers, using selection criteria that includes metrics other than signal strength. The connectivity management service acquires performance data relating to the operation of a plurality of sectors. The connectivity management service can direct the endpoint device to perform measurements and compute metrics directly. The connectivity management service can also receive reports of performance data from neighboring devices, where the reports include performance data for one or more sectors in the geographic region. The connectivity management service can also receive reports of performance data from the back office. The performance data can include measurements and/or calculations associated with the reliability, latency, and/or capacity of a given sector. The connectivity management service determines connectivity performance metrics for a plurality of sectors and determines whether to switch to a different carrier and/or a different sector based on a comparison of the connectivity performance metrics. In this manner, multiple endpoint devices that execute instances of the connectivity management service can autonomously determine whether to change the sector and/or the carrier network. Endpoint devices that have lower signal strengths and/or higher disconnection rates expend additional energy, as such endpoint devices attempt communication multiple times and otherwise struggle to complete data transfers. These endpoint devices also use more capacity than endpoint devices that possess better connectivity. Overall, multiple endpoints that independently switch between sectors maximize the available capacity across multiple sectors, reducing the energy consumption associated with multiple disconnections.

When selecting a carrier network and/or network sector for connection, the connectivity management service can acquire network performance data for multiple network sectors. The network performance data can be collected by the endpoint device and/or other devices (e.g., neighboring endpoint devices, a back office, etc.). The connectivity management service can compute connectivity performance metrics and select, based on the connectivity performance metrics, a sector for connection. For example, the connectivity management service can determine an estimated total allocated capacity and/or an estimated available capacity for a plurality of sectors. The connectivity management service can also collect other network performance data, including latencies of neighboring endpoint devices (e.g., time to provide the data), and/or indications of connection failures from the neighboring endpoint devices. The connectivity management service can then compute connectivity performance metrics for the respective sectors, such as a weighted sum of latency and network capacity.

The connectivity management service uses the connectivity performance metrics to select a specific sector with which the endpoint is to establish a connection. Based on the selected sector, the connectivity management service can then cause a cellular modem of the endpoint device to select the specific sector for connection. In some instances, the connectivity management service can modify a directional antenna pattern employed by transceivers of the endpoint device. The change in the directional antenna pattern causes the selected sector to exhibit a higher signal strength relative to other sectors. The cellular modem then uses the default connection criteria to connect to the selected sector. the selection criteria employed by the endpoint device is dictated by a communication standard (e.g., a cellular communication standard) such that use of these selection criteria is required to comply with the standard. Using the techniques disclosed herein, an endpoint device can comply with the standard while also selectively connecting to a particular sector.

At least one technical advantage of the disclosed techniques is that the disclosed techniques increase the connectivity of endpoint devices deployed in an environment, increasing the reliability of connections via carrier networks. In particular, by enabling endpoint devices to analyze network performance data, the endpoint device can determine which carrier networks, and which network sectors provide the best combination of network reliability, capacity and latency. Further, the disclosed techniques reduce disconnection rates and power usage of an endpoint device while balancing available capacity across multiple sectors. Additionally, the disclosed techniques further increase overall actual capacity across all sectors and increase battery lifetime for battery-powered endpoint devices.

### Networked Environment

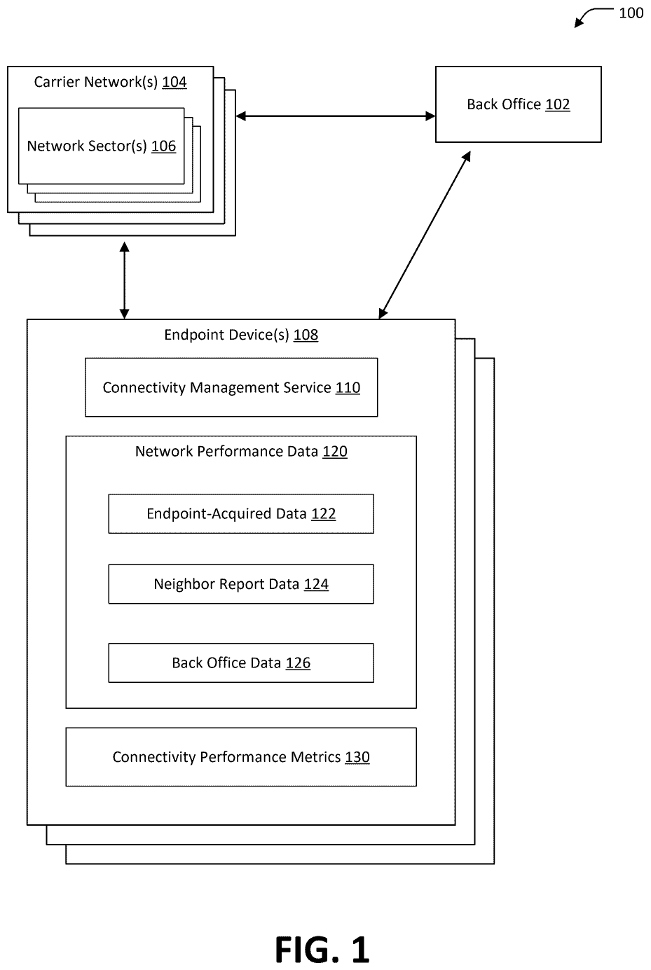

FIG. 1 is a conceptual diagram of a networked environment 100 for a connectivity management service, according to various embodiments. As shown, the networked environment 100 includes, without limitation, a back office 102, one or more carrier networks 104, one or more network sectors 106, and one or more endpoint devices 108. The endpoint device 108 includes, without limitation, a connectivity management service 110, network performance data 120, and connectivity performance metrics 130. The network performance data 120 includes, without limitation, endpoint-acquired data 122, neighbor report data 124, and back office data 126.

The one or more carrier networks 104 provide a cellular or other type of wide area network. Each of the one or more carrier networks 104 includes one or more network sectors 106. A given carrier network 104 includes, without limitation, one or more towers, one or more base stations, one or more network devices such as routers, switches, and gateways, one or more radio communications devices, and so on. The carrier network 104 provides one or more base stations corresponding to one or more cells. Each cell includes one or more network sectors 106, such as one, two, three, four, five, six, or more network sectors 106. As a result, a carrier network 104 provides network coverage using the plurality of network sectors 106 over a geographic area.

The back office 102 represents one or more computing devices, services, or systems that communicate with the carrier networks 104 and/or the endpoint devices 108. In various embodiments, the back office 102 includes one or more server machines (not shown) configured to operate as sources for, and/or destinations of, data packets that traverse within the network system. In various embodiments, the back office 102 queries the carrier networks 104 and/or the endpoint device 108 to obtain various data, including raw and/or processed sensor data, power consumption data, node/network throughput data, status information, and so forth. In some embodiments, the back office 102 also transmits commands and/or program instructions to the endpoint devices 108 to cause the endpoint devices 108 to perform various operations. In some embodiments, each server machine included in the back office 102 a computing device configured to execute, via a processor, a software application stored in a memory to perform various network management operations.

In various embodiments, the back office 102 generates and transmits the back office data 126 to the endpoint device 108. The back office data 126 includes information about a deployment of endpoint devices 108 within a geographic region. For example, the back office data 126 can include values such as a total number of endpoint devices 108 that are on a given carrier network 104, tower, and/or network sector 106. The back office data 126 can also include performance-related measurements and/or statistics. For example, the back office data 126 can include a value indicating a percentage of successful interrogation responses based on a given carrier network 104, tower, and/or network sector 106.

The one or more endpoint devices 108 can be nodes in the networked environment that connect to any of the network sectors 106 included in any of the carrier networks 104. In some examples, the endpoint device 108 is a stationary device statically located in a particular geographic location. A given endpoint device 108 uses one or more processors to execute the connectivity management service 110. The endpoint device 108 uses one or more storages devices to store instructions, including the connectivity management service 110, as well as the network performance data 120. In some embodiments, the endpoint device 108 stores a subscriber identity module (SIM) identifier that is usable to connect to the one or more carrier networks 104. The SIM identifier refers to an International Mobile Subscriber Identity (IMSI) number or another identifier that uniquely identifies a particular SIM. In some embodiments, the endpoint device 108 stores a multi-carrier SIM. In such instances, the SIM identifier identifies one of the individual SIMs. The multi-carrier SIM enables the endpoint device 108 to connect to multiple different carrier networks 104.

The connectivity management service 110 manages the connections maintained by the endpoint device 108 to the one or more carrier networks 104. In various embodiments, the connectivity management service 110 executes instructions to connect to a single carrier network 104 by transmitting instructions (e.g., suspend and resume instructions) to individual carrier networks 104 such that the endpoint device 108 maintains a single connection to a single network sector 106 of a single carrier network 104. In various embodiments, the connectivity management service 110 controls the endpoint device 108 collecting and storing a plurality of types of network performance data 120. For example, the connectivity management service 110 can cause the endpoint device 108 to observe, measure, and/or calculate a set of endpoint-acquired data 122. Additionally or alternatively, the connectivity management service 110 causes the endpoint device 108 to store sets of neighbor report data 124 received from a neighboring endpoint device 108 and/or back office data 126 received from the back office 102.

In various embodiments, the connectivity management service 110 manages the connection of the endpoint device 108 to the one or more carrier networks 104 by identifying a specific carrier network 104, a specific tower, and/or a specific network sector 106 for connection. For example, the connectivity management service 110 can process the network performance data 120 to generate connectivity performance metrics 130; a given connectivity performance metric 130 corresponds to a specific carrier network 104, tower, and/or a specific network sector 106. When determining whether to change connections between network sectors, the connectivity management service 110 can use the connectivity performance metrics 130 for a plurality of network sectors 106 to identify the specific network sector 106. For example, the connectivity management service 110 can compute connectivity performance metrics 130 for a plurality of network sectors 106, where one or more of the connectivity performance metrics 130 are based on data extracted from one or more of the endpoint-acquired data 122, the neighbor report data 124, and/or the back office data 126. In such instances, the connectivity management service 110 can then compare the performance metrics 130 to select a specific network sector 106 for connection. In some embodiments, the connectivity management service 110 can apply a randomness factor when determining whether to trigger a switch. In such instances, the applied randomness factor can ensure that a percentage of endpoint devices 108 remain connected even when the connectivity performance metrics 130 indicate that the endpoint device 108 should perform a switch.

In various embodiments, the connectivity management service 110 can also determine the relative signal strengths of multiple carrier networks 104, towers, and/or network sectors 106. In some embodiments, the connectivity management service 110 can incorporate the relative signal strengths into the connectivity performance metrics 130. For example, the connectivity managements service 110 can weight relative signal strengths of network sectors 106 to indicate the relative amount of energy necessary for the endpoint device 108 to establish a connection, where lower signal strengths indicate a larger amount of energy required. Additionally or alternatively, in some embodiments, the connectivity management service 110 refers to the relative signal strengths to determine whether the endpoint device 108 is likely to select a specific carrier network 104, tower, and/or network sector 106 for connection.

For example, when the connectivity management service 110 determines that a specific network sector 106 does not have the highest signal strengths relative to other network sectors 106, the connectivity management service 110 determines that the endpoint device 108 is not likely to select the specific network sector 106 for connection. When comparing relative signal strengths, the connectivity management service 110 can determine an expected signal strength for the specific network sector 106 relative to other network sectors 106 when the endpoint device 108 employs a given directional antenna pattern.

In some embodiments, determining that the endpoint device 108 is not likely to select the specific network sector 106, the connectivity management service 110 can respond by changing the signal strengths of the network sectors 106 in order to steer the endpoint device 108 to selecting the specific network sector 106. In such instances, the connectivity management service 110 generates commands that cause the endpoint device 108 to change the directional antenna pattern in use. In this manner, the connectivity management service 110 can alter the relative signal strengths of multiple network sectors 106 that the endpoint device 108 measures. Changing the signal strengths of the network sectors 106 thereby controls whether the specific network sector 106 has the highest relative signal strength. The connectivity management service 110 can thus cause the endpoint device 108 to employ a directional antenna pattern that results in the specific network sector 106 having the highest relative signal strength. As a result, a cellular modem of the endpoint device 108, employing the default connection criteria, selects the specific network sectors 106 for connection. In some embodiments, the default connection criteria is dictated by a communications standard (e.g., a cellular communication standard) such that use of these selection criteria is required to comply with the standard.

The network performance data 120 includes, without limitation, network-level performance information for a particular carrier network 104, region-level performance information specific to a region where the SIM (and endpoint device 108) is located, and/or SIM-level information specific to network performance of the multi-carrier SIM (and endpoint device 108) in communications using the particular carrier network 104. In some examples, different carrier networks 104 provide several types of network performance data 120 including different parameters, different sets of parameters, and/or data different formats. Additionally or alternatively, in some embodiments, the connectivity management service 110 also collects other network performance data 120, including latencies of neighboring endpoint devices 108 (e.g., time elapsed between a request message and a response message) and/or indications of connection failures from the neighboring endpoint devices 108. In such instances, the data can be included in one or more of the endpoint-acquired data 122, the neighbor report data 124, and/or the back office data 126.

The endpoint-acquired data 122 includes various carrier data, tower data, and/or sector data that the endpoint device 108 observes, measures, or directly calculates. In various embodiments, the endpoint device 108 makes any number of measurements over a period of operation. The measurements can be related to the ability of the endpoint device 108 to obtain, maintain, and/or use a connection to a specific measured carrier network 104, tower, and/or network sector 106. In various embodiments, the endpoint-acquired data 122 includes measurements such as latency measurements, such as the latency of round-trip transmissions (e.g., network time synchronization) or delay between requesting and obtaining a radio resource control (RRC) connection. The endpoint-acquired measurements can also include reliability measurements, such as the number of repetition attempts (e.g., re-registration attempts after an outage) or registration failures, such as failures to sense a valid network sector 106 or otherwise fail to register to a carrier network 104. The endpoint-acquired data 122 can also include the signal strength of the carrier network 104, tower, and/or network sector 106.

The neighbor report data 124 includes data that one or more neighboring endpoint devices 108 share over a local connection (e.g., a WiFi connection, a radio frequency (RF) mesh connection, etc.). To this end, the connectivity management service 110 can periodically request the neighbor report data 124 from one or more remote devices (e.g., one or neighboring endpoint devices 108 and/or the back office 102) in the networked environment 100. In various embodiments, the neighbor report data 124 includes information about a neighboring endpoint device. For example, the neighbor report data can include system information such as device type (e.g., type of meter, type of battery-powered device, etc.), CPU usage, memory utilization, software installed and/or executing, device uptime, device (e.g., software and firmware) error rates, transaction volumes, system alerts, device hardware, and so forth. The neighbor report data 124 can also include physical information and measurements, such as physical information of the endpoint device 108 such as a device location, temperature, humidity, air pressure, elevation. Additionally or alternatively, the neighbor report data 124 can include enterprise-specific analytics such as anticipated peak data load, anticipated average data load, and identification information about the carrier network 104, tower, and/or network sector 106 to which the neighboring endpoint device 108 is currently attached. Additionally or alternatively, the neighboring report data 124 can include similar data to the data included in the endpoint-acquired data 122. In such instances, the neighboring endpoint device acquires a set of endpoint-acquired data (e.g., measurements related to the ability of the neighboring endpoint device to obtain, maintain, and/or use a connection to the carrier network 104, tower, and/or network sector 106 to which the neighboring endpoint device is attached). The neighboring endpoint device can then include the acquired set of endpoint-acquired data in the neighbor report data. In some embodiments, the endpoint device 108 receives the network report data 124 over a different connection than the connection established between the endpoint device 108 and the current network sector 106.

The back office data 126 includes information about a deployment of endpoint devices 108 within a geographic region. In various embodiments, the back office data 126 can include loading statistics that the back office 102 has determined. In various embodiments, the back office data 126 can include deployment data aggregated from report data transmitted from a plurality of endpoint devices 108 (e.g., data that is included in the neighbor report data 124). Such data can include the number of deployed endpoint devices 108 that are known to be in a given area or network sector 106, the percentage of failures (e.g., a round trip failure percentage indicating how many times the back office 102 had to repeat a message to an endpoint device 108), latency averages across a network sector 106, a computed actual capacity, an estimated capacity, an aggregated packet reliability value, and so forth. In various embodiments, the back office 102 can periodically transmit the back office data 126, such as transmitting the back office data 126 during regularly scheduled interactions (e.g., during a heartbeat check).

The connectivity performance metrics 130 refer to metrics associated with the reliability and health of a connection when the endpoint device 108 connects to a specific carrier network 104, tower, and/or network sector 106. Such capabilities are critical to maintaining usable and flexible cellular infrastructure. In various embodiments, the connectivity management service 110 can determine from one or more measurements beyond defined thresholds that a high number of endpoint devices 108 on a given tower or network sector 106 (“loading”) are negatively affecting performance of the given tower or network sector 106. In such instances, the connectivity management service 110 can respond by causing the endpoint device 108 to disconnect from the current connection and attempt a switch to a different carrier network 104, tower, or network sector 106.

In various embodiments, the connectivity management service 110 can compute one or more connectivity performance metrics 130 for one or more of the identified carrier networks 104, towers, and/or network sectors 106. For example, the connectivity management service 110 can identify a plurality of network sectors 106. In such instances, the connectivity management service 110 can compute, for each networks sector 106 of the plurality of network sectors 106, a connectivity performance metric 130. The connectivity management service 110 can then compare the performance metrics 130 corresponding to the respective network sectors 106 to select a specific network sector 106 for connection.

### The Endpoint Device

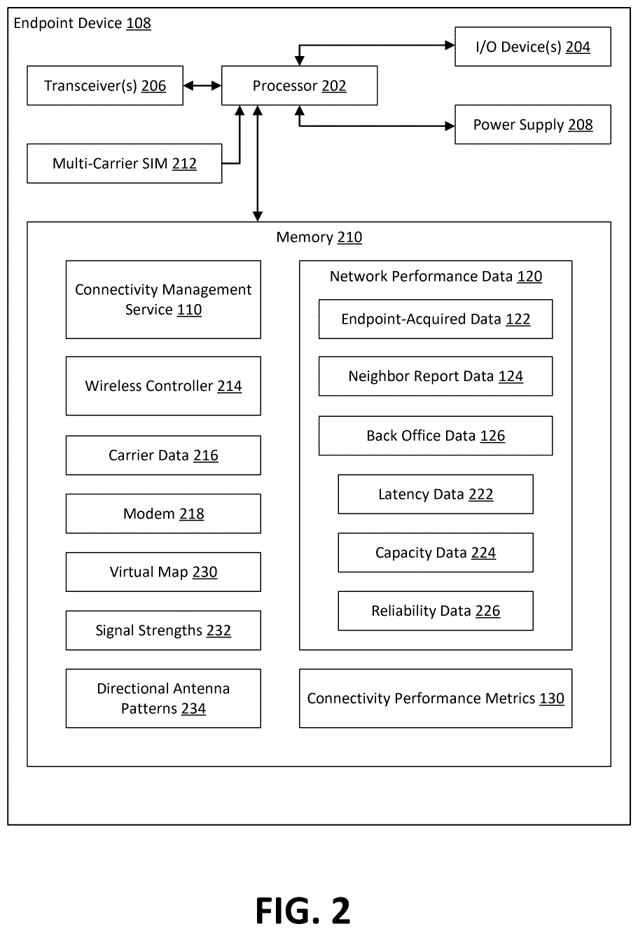

FIG. 2 illustrates a more detailed view of an endpoint device 108 of FIG. 1, according to various embodiments. As shown, the endpoint device 108 includes, without limitation, a processor 202, one or more input/output (I/O) devices 204, one or more transceivers 206, a power supply 208, memory 210, and a multi-carrier SIM 212. The memory 210 includes, without limitation, the connectivity management service 110, the network performance data 120, the connectivity performance metrics 130, a wireless controller 214, carrier data 216, a modem 218, a virtual map 230, one or more signal strengths 232, and one or more directional antenna patterns 234.

The endpoint device 108 can be any communication device that communicates with devices in a network via a carrier network, such as the carrier network 104. In one example, the endpoint device 108 is a utility metering device that is coupled to, or included within, a utility distribution infrastructure in which the endpoint device 108 monitors consumption of a utility commodity (e.g., water, gas, electricity, etc.). In other embodiments, the endpoint device 108 is a smart streetlight. In still other embodiments, the endpoint device 108 is a demand control device, such as a shut-off switch for a pool pump, an air conditioning unit, and/or the like.

The processor 202 coordinates operations of endpoint device 108. In various embodiments, the processor 202 includes any hardware configured to process data and execute software applications. The processor 202 can be any technically feasible processing device configured to process data and execute program instructions. For example, the processor 202 can include one or more central processing units (CPUs), DSPs, graphics processing units (GPUs), application-specific integrated circuits (ASICs), field-programmable gate arrays (FPGAs), microprocessors, microcontrollers, other types of processing units, and/or a combination of different processing units. The processor 202 can include a real-time clock (RTC) (not shown) according to which the processor 202 maintains an estimate of the current time. The estimate of the current time can be expressed in Universal Coordinated Time (UTC), although any other standard of time measurement can also be used.

The one or more I/O devices 204 include devices configured to receive input, devices configured to provide output, and devices configured to both receive input and provide output. As described above, in some examples, the endpoint device 108 is a utility metering device that is coupled to, or included within, a utility distribution infrastructure. In this example, the one or more I/O devices 204 can further include one or more data acquisition devices that are used by endpoint device 108 to monitor consumption of a utility commodity (e.g., water, gas, electricity, etc.). For example, the one or more I/O devices 204 can further include one or more of an electricity meter, a gas meter, a water meter, or some other type of sensor used to monitor consumption of a utility commodity.

The one or more transceivers 206 are configured to establish one or more communications channels and transmit messages to and/or receive messages from other devices in the network (e.g., one or more neighboring endpoint devices 108, an access point the carrier network 104, the back office 102, etc.). The one or more transceivers 206 can be implemented as any suitable transmission and/or reception device. In some embodiments, the one or more transceivers 206 include a plurality of antennas in an antenna array. For example, the antenna array can be a phased array that generates a steerable directional radiation pattern in a specific direction. In some examples, the one or more transceivers 206 can operate in a first communication mode in which the one or more transceivers 206 communicate with one or more devices in a first type of network. The one or more transceivers 206 can also operate in a second communication mode in which the one or more transceivers 206 communicate with one or more devices in a second type of network. For example, while in the first communication mode, the transceivers 206 establish a first communications channel and transmits messages to and/or receives messages from devices in a first type of network (e.g., a Cat-M1 network) via a first type of access point. As another example, while in the second communication mode, the transceivers 206 establish a second communication channel and transmits messages to and/or receives messages from devices in a second type of network (e.g., a NB-IoT network) via a second type of access point. In operation, the one or more transceivers 206 can transition between communication modes. In some examples, the one or more transceivers 206 can operate in more than two communication modes and/or communicate with devices in more than two different types of networks.

The power supply 208 provides power to one or more of the components included in endpoint device 108. For example, the power supply 208 powers one or more of the processor 202, the I/O devices 204, the transceivers 206, and the memory 210. In some examples, the power supply 208 is connected to mains-power such that the power supply 208 powers one or more components of endpoint device 108 with mains-power. In some examples, the power supply 208 includes a battery that is used to provide power to one or more components of endpoint device 108.

The multi-carrier SIM 212 includes any SIM that enables communication with multiple carrier networks 104 and network sectors 106. The multi-carrier SIM 212 can refer to a removable SIM or a device integrated SIM such as an eSIM or an iSIM. Various examples of the multi-carrier SIM 212 include an integrated circuit located on a removable SIM card, an integrated circuit component that is permanently installed to the endpoint device 108, or a software SIM stored by a component of the endpoint device 108. In some embodiments, the multi-carrier SIM 212 includes two or more profiles. In such instances, a given profile configures the multi-carrier SIM 212 (and the endpoint device 108) to use a specified network sector 106 and/or a specified carrier network 104.

The memory 210 can include any technically feasible storage device, such as a random-access memory (RAM) module, a flash memory unit, a hard disk drive, non-volatile storage, or any other type of memory unit or combination thereof. The memory 210 is shown storing executable components of the connectivity management service 110, the wireless controller 214, the modem 218, as well as data including the network performance data 120, the connectivity performance metrics 130, the carrier data 216, the virtual map 230, the signal strengths 232, and the directional antenna patterns 234.

The wireless controller 214 controls the operation of the one or more transceivers 206 to communicate with other devices in the networked environment 100. In various embodiments, the transceivers 206 can form a phased array that receives a feed current controlled by the wireless controller 214. In such instances, the connectivity management service 110 can transmit a command to the wireless controller 214 for the transceivers 206 to operate using a specific directional antenna pattern 234. The wireless controller 214 can respond to the command by using one or more phase shifters (not shown) and/or other hardware to control the transceivers 206 to operate using the selected directional antenna pattern 234.

The modem 218 transmits data via the transceivers by converting data from a digital format into a format suitable for an analog transmission medium. In various embodiments, the modem 218, based on connection criteria, controls which available carrier network 104, available tower, and/or available network sector 106 is selected for connection. In various embodiments, the connection criteria can be a default type, such as the relative signal strengths of the network sectors 106. In some embodiments, the type of connection criteria is dictated by a communications standard (e.g., a cellular communication standard) such that use of these selection criteria is required to comply with the standard. In some embodiments, the connection criteria specify a priority list of carrier networks 104 (e.g., a list contained in the multi-carrier SIM 212). In such instances, the modem 218 can select one of the network sectors 106 of the highest-priority carrier network 104 for connection.

The carrier data 216 includes information about carrier networks 104 within a networked environment 100 (see FIG. 1). In some embodiments, the carrier data 216 includes a plurality of carrier-specific data records, including information such as a carrier identifier, sector identifiers, device identifiers, and protocols. The carrier identifier includes identifying information for the carrier network 104, including a universally unique identifier (UUID) or another value that identifies the carrier network 104. The sector identifiers include identifying information (e.g., UUID or another value) for respective ones of the network sectors 106 of the carrier network 104. The device identifiers include device identifying information for respective ones of a set of endpoint devices 108 connected to the various network sectors 106 of the carrier network 104. The device identifiers include a unique device identifier (UDID), a UUID, an International Mobile Subscriber Identity (IMSI) of a SIM of the endpoint device 108, or another value. The protocols include one or more protocols used for communications using the carrier network 104 and/or individual network sectors 106. The protocols include fifth-generation new radio (5GNR), various fourth generation categories (4G Cat-X), 4G Cat M1, Narrowband Internet of Things (NB IoT), and/or the like.

The connectivity management service 110 processes the network performance data 120 to generate the connectivity performance metrics 130. The connectivity management service 110 processes the network performance metrics 130 to determine a specific carrier network 104, tower, and/or network sector 106 for connection. The connectivity management service 110 also monitors the signal strengths 232 of a plurality of carrier networks 104, towers, and/or network sectors 106. In such instances, the connectivity management service 110 can include the signal strengths 232 when generating the connectivity performance metrics 130.

Additionally or alternatively, in various embodiments, the connectivity management service 110 processes the signal strengths 232 to predict the selection of the modem 218. For example, the connectivity management service 110 can compare the signal strengths 232 of a plurality of network sectors 106 to determine which network sector 106 the modem 218 will likely select for connection when using the default connection criteria (which emphasizes the signal strengths 232 as the primary criteria). When the signal strength 232 of the specific network sector 106 is not the highest among the signal strengths 232, the connectivity management service 110 selects one of the directional antenna patterns 234 for use by the transceivers 206. In various embodiments, the connectivity management service 110 selects a directional antenna pattern 234 where the specific network sector 106 is likely to have the highest signal strength 232. In such instances, the connectivity management service 110 adjusts the transceivers to operate using the selected directional antenna pattern 234 in order for the specific network sector 106 to have the highest corresponding signal strength 232.

In various embodiments, the endpoint device 108 acquires the network performance data 120 over a first defined period. For example, the connectivity management service 110 can perform a sweep of network sectors 106 within the networked environment 100 and acquire the endpoint-acquired data 122 within the first defined period (e.g., one week) for a plurality of the network sectors 106. Additionally or alternatively, in some embodiments, the endpoint device 108 stores the network performance data 120 for a second defined period (e.g., storing the endpoint-acquired data 122 for a day, a week, a month, etc.). The second defined period for storing the network performance data 120 can differ from the first defined period for acquiring one or more types of network performance data (e.g., the endpoint-acquired data 122, the neighbor report data 124, the back office data 126, etc.).

In various embodiments, the connectivity management service 110 extracts the latency data 222, the capacity data 224, and/or the reliability data 226 from one or more of the endpoint-acquired data 122, the neighbor report data 124, and/or the back office data 126. For example, the connectivity management service 110 can process the endpoint-acquired data 122 and extract latency data 222, capacity data 224, and reliability data 226 for the network sector 106 to which the endpoint device 108 is currently connected. The connectivity management service 110 can also process the neighbor report data 124 and the back office data 126 and extract latency data 222, capacity data 224, reliability data 226 for a plurality of additional network sectors 106 to which one or more neighbor endpoint devices 108 are connected or to which the back office 102 received report information from a deployment of endpoint devices 108. In some embodiments, the connectivity management service 110 can request the neighbor report data 124 and/or the back office data 126 at the same time (e.g., concurrently, with partial concurrence, or sequentially). In such instances, the reporting period for responses received by the endpoint device 108 can act as a stress test on the carrier network 104, tower, or network sector 106 being measured. For example, the connectivity management service 110 can measure the time required to receive the neighbor report data 124 and/or the back office data 126 over a specific network sector 106. If the specific network sector 106 is heavily loaded, an aggregate metric for the specific network sector 106 corresponding to a sector latency value can be higher relative to a lightly loaded network sector 106.

The latency data 222 represents the respective latencies of respective carrier networks 104, towers, and/or network sectors 106. The capacity data 224 represents the respective capacities (e.g., the estimated available capacity, the actual available capacity, and/or the total allocated capacity) of respective carrier networks 104, towers, and/or network sectors 106. The reliability data 226 represents the respective reliabilities (e.g., connection loss, packet loss, etc.) respective carrier networks 104, towers, and/or network sectors 106. In various embodiments, the connectivity management service 110 can aggregate or process multiple data values included in the endpoint-acquired data 122, the neighbor report data 124, and/or the back office data 126 to generate the respective latency data 222, capacity data 224, and/or the reliability data 226. For example, the connectivity management service 110 can aggregate a measured dynamic latency (e.g., measurements from a ping event) included in the endpoint-acquired data 122 and RRC connection latencies included in the neighbor report data 124 to generate latency data 222 for a plurality of network sectors 106.

The latency data 222 can include various sector-specific latency metrics (e.g., average, mean, upper quartile, lower quartile etc.) for respective ones of the network sectors 106. In various embodiments, the connectivity management service 110 can calculate a sector latency value (L) using the latency data 222. In some embodiments, the latency data 222 can include one or more measurements made by devices in a geographic region. For example, the latency data can include measurements of RRC connection latency, dynamic latency (e.g., latency measured during an occurrence of a coordinated simultaneous communication), and/or packet latency (e.g., negotiated data rate, granted slots for data transmission, etc.

The capacity data 224 can include sector-specific capacity metrics (e.g., the estimated available capacity, the actual available capacity, and/or the total allocated capacity) for respective ones of the network sectors 106. In various embodiments, the connectivity management service 110 computes a single capacity value (C) to represent the capacity of a network sector 106. For example, connectivity management service 110 can set the capacity value as the actual sector capacity included in the capacity data 224. The available sector capacity corresponds to a difference between an estimated (e.g., total) sector capacity and a capacity used by non-enterprise devices (e.g., alternate load).

In various embodiments, the connectivity management service 110 can compute the capacity data 224 from the latency data 222 and/or the reliability data. For example, the connectivity management service 110 can generate the estimated available capacity based on reliability measurements (e.g., required number of repetitions for an operation) and latency measurements (e.g., RRC connection latency). In some embodiments, the connectivity management service 110 uses other network performance data 120, such as disconnection rates, signal strengths 232, and/or the like to identify the available sector capacity and/or the alternate load. In some embodiments, the capacity data 224 determined by the endpoint device 108 includes the estimated sector capacity. The estimated sector capacity is a sector-specific upper limit (and/or available) capacity that is based on one or more protocols used by the network sector 106 and an allocated capacity, such as a service-level capacity according to a contract with the corresponding carrier network 104. The connectivity management service 110 identifies an estimated sector capacity for a given network sector 106, where the network sector 106 corresponds to a given carrier network 104.

The reliability data 226 includes various sector-specific reliability metrics (e.g., average, mean, upper quartile, lower quartile etc.) for respective ones of the network sectors 106. In various embodiments, the reliability data 226 can include observations, such as the complete loss of connectivity (e.g., failure to register), as well as measurements, such as the amount of time taken to register the endpoint device 108 with a specific network sector 106. Other reliability measurements can include an amount of time that the endpoint device 108 failed to receive communications (e.g., an average time of connection loss over a given time period), packet reliability (e.g., required number of repetitions for a mandatory operation), and so forth.

In various embodiments, the connectivity management service 110 can compute connectivity the performance metrics 130 for the plurality of network sectors 106 by retrieving, for each network sector 106, a latency value (L) from the latency data 222, a capacity value (C) from the capacity data 224, and/or a reliability value (R) from the reliability data 226. The connectivity management service 110 can then compute a performance value (PV) based on a combination of the latency value, the capacity value, and/or the reliability value. In one example, the connectivity management service 110 computes the performance values as a weighted sum of the latency value, the capacity value, and the reliability value, as shown in Equation 1:

$$P V = x / L + y C + z / R \qquad ( 1 )$$

In some embodiments, the connectivity management service 110 computes the performance value as a ratio of the latency value and the capacity value, as shown in Equation 2:

$$PV = h * ( C / RL ) \qquad ( 2 )$$

where h, x, y, and z are constant values. In both of the above instances, the performance value increases as the capacity value increases and/or the latency value decreases.

In various embodiments, the connectivity management service 110 can compute performance values for one or more of the networks sectors 106 in one or more of the carrier networks 104. In such instances, the connectivity management service 110 can compare the performance values corresponding to multiple network sectors 106 and identify a network sector 106 for connection based on the performance values. Additionally or alternatively, in various embodiments, the connectivity management service 110 can apply one or more constant values to the performance values. For example, the connectivity management service 110 can apply a randomness factor to the performance values. In such instances, the connectivity management service 110 can compare the resultant performance values and determine not to perform a switch. In this manner, a percentage of a plurality of endpoint devices 108 maintain the same connection, ensuring that not all endpoint devices 108 attempt to switch autonomously.

In some embodiments, the endpoint device 108 is configured to perform an optimization search. In such instances, various gain values and/or phase coefficients are applied to a dynamic search. In such instances, when the endpoint device 108 dynamically searches among multiple sectors, the endpoint device 108 searches for the best set of coefficients that optimizes a desired sector (or, conversely, the set of coefficients that lower the performances of one or more non-desired sectors).

The directional antenna patterns 234 are one or more stored directional patterns that the transceivers 206 can employ when communicating with other devices. In various embodiments, the wireless controller 214 can control the one or more transceivers 206 to emit electromagnetic energy in a manner where the signal strength 232 varies significantly based on the direction of the transceivers 206. In various embodiments, the wireless controller 214 can modify the operation of the transceivers 206 to operate using various types of directional antenna patterns 234, where the main lobe of radiation has a different shape and can be set at various directions relative to the transceivers 206. In various embodiments, the endpoint device 108 can store multiple types of directional antenna patterns 234 in the memory 210. For example, the directional antenna patterns 234 can include, without limitation, one or more a cardioid-type patterns (e.g., cardioid, super-cardioid, hyper-cardioid etc.), one or more lobar-type patterns, one or more bidirectional patterns, and so forth.

Additionally or alternatively, the connectivity management service 110 can associate specific directional antenna patterns 234 with specific network sectors 106 (e.g., a mapping that the specific network sector 106 will have an expected sector signal strength 232 when operating using the specific directional antenna pattern 234). In such instances, the connectivity management service 110 can identify a directional antenna pattern type or a specific directional antenna pattern 234 to employ upon selecting the specific network sector 106.

The signal strengths 232 includes one or more signal strengths of specific carrier networks 104, towers, and/or network sectors 106. In various embodiments, the endpoint device 108 acquires signal strength measurements for one or more carrier networks 104, towers, and/or network sectors 106. In such instances, the signal strengths are relative signal strengths based on the location and configuration of the endpoint device 108. In various embodiments, the signal strengths 232 are quantitative values, such as a received signal strength indicator (RSSI), reference signal received power (RSRP), and/or received signal code power (RSCP). In some embodiments, the connectivity management service 110 includes the signal strength (S) when computing the connectivity performance metrics, as shown in Equation 3:

$$P V = x / L + y C + z / R + g S \qquad ( 3 )$$

In various embodiments, the connectivity management service 110 can refer to the signal strengths 232 to determine which carrier network 104, tower, and/or network sector 106 the modem 218 is likely to select. The connectivity management service 110 can respond to this determination by triggering the endpoint device 108 to operate using a different directional antenna pattern 234, thus causing one or more of the signal strengths 232 to change. For example, the connectivity management service 110 can use one or more computed connectivity performance metrics 130 to identify a specific network sector 106 for selection by the modem 218. The connectivity management service 110 can then refer to the signal strengths 232 to determine whether the specific network sector 106 has the highest sector signal strength 232. In instances where the connectivity management service 110 determines that the specific network sector 106 does not have the highest sector signal strength 232, the connectivity management service 110 can respond by selecting a different directional antenna pattern 234 (e.g., a directional antenna pattern 234 where the specific network sector 106 has the highest sector signal strength 232). The connectivity management service 110 performs a beamforming technique on the transceivers 206 via the wireless controller 214 to operate using the selected directional antenna pattern 234.

The virtual map 230 is a map that the connectivity management service 110 generates to estimate the locations of network sectors 106 and a plurality of endpoint devices 108 in a geographic region. In various embodiments, the virtual map includes sector locations indicating a geographic area or location where the network sector 106 provides network connectivity. The sector location can be indicated using one or more perimeter lines, a diameter from a particular location, and/or the like. The virtual map 230 also includes the estimated locations of one or more neighboring endpoint devices 108. In various embodiments, the connectivity management service 110 can build the virtual map 230 and use the virtual map when identifying a set of network sectors 106 that are available for connection. The connectivity management service 110 can also estimate the available sector capacities for the set of network sectors 106 in order to identify a second network sector 106(2) for the endpoint device 108 to establish a new connection in lieu of the existing connection with a first network sector 106(1).

In various embodiments, the connectivity management service 110 determines to switch between network sectors 106 based on the virtual map 230, where a percentage of the endpoint devices 108 within a given geographic region are expected to observe a condition and autonomously migrate to a different network sector 106. In such instances, each given endpoint device 108 can apply a randomness factor to the performance value to determine whether to switch to a different network sector 106; as a result, a specified percentage of endpoint devices 106 switch network sectors 106 upon recognizing a condition. For example, each connectivity management service 110 can apply a set of rules for switching, such as a first rule where 100% of endpoint devices 108 included in a geographic region should attempt to switch to a different carrier network 104 after 24 hours without carrier registration. A second rule specifies that 5% of endpoint devices 108 observing RRC latencies of at least one minute connected to a first network sector 106(1) with neighboring endpoints 108 on alternate network sectors 106(2)-106(3) that observe RRC obtain latencies below 30 seconds shall migrate after 12 hours of observing this condition. A third rule specifies that 15% of endpoint devices 108 in network sectors 106(1)-106(2) with loading of deployed endpoint devices 108 at 70% of nominal and observing RRC latencies of at least 2 minutes shall migrate after 48 hours of observing this condition. If a given endpoint device 108 does not migrate, the endpoint device 108 shall reset the 48 hour analysis period.

In various embodiments, the connectivity management service 110 determines to change from the first network sector 106 to the second network sector 106 based on the signal strengths 232 indicating a lower signal strength and/or the network performance data 120 a higher disconnection rate relative to other endpoint devices 108 located proximate to the endpoint device in the virtual map 230. In such instances, switching to a different network sector 106 can improve battery life for the endpoint device 108, as well as reduce bandwidth usage in one or more network sectors 106. In this manner, each connectivity management service 110 can cause a given endpoint device 108 to autonomously load balance by identifying available sector capacities for the first and second network sectors 106, and determining that the second (e.g. destination) network sector 106 is associated with a higher available sector capacity relative to the first network sector 106. As a result, the available sector capacities are more balanced once the endpoint device 108 changes from the first network sector 106 to the second network sector 106. Further, one or more endpoint devices 108 can switch from a network sector 106 that is in full breakdown without needing to receive commands from a back office 102 (which would otherwise be unreachable).

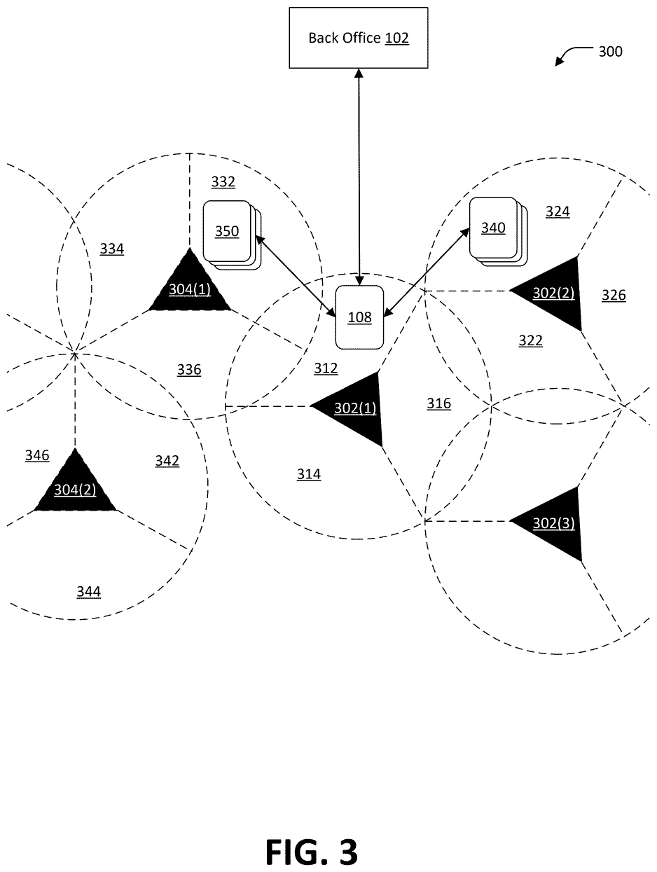

FIG. 3 illustrates an example of a networked environment 300 that includes multiple carrier networks 104 and the endpoint device 108 of FIG. 1, according to various embodiments. As shown, the networked environment 300 includes, without limitation, a first carrier network 302 (e.g., 302(1), 302(2), 302(3), etc.), a second carrier network 304 (e.g., 304(1), 304(2), etc.), the endpoint device 108, the back office 102, and neighboring endpoint devices 340 (e.g., 340(1), 340(2), etc.) and 350 (e.g., 350(1), 350(2), etc.). The carrier network 302(1) includes without limitation, network sectors 312, 314, 316, 322, 324, 326. The carrier network 304(1) includes, without limitation, network sectors 332, 334, 336, 342, 344, 346.

Each of the carrier networks 302, 304 provides a cellular or other type of wide area network. A given carrier network 302, 304 includes multiple network sectors (e.g., the network sectors 312-326 for the carrier network 302), among other network sectors 106 that are unlabeled in the figure. The first carrier network 302 includes one or more base stations (and other hardware) in one or more towers indicated by the triangles labeled “302(x)” (e.g., 302(1), 302(2), 302(3), etc.). The second carrier network 304 provides a cellular or other type of wide area network that includes network sectors 332-346, among other network sectors 106 that are unlabeled in the figure. The second carrier network 304 includes one or more base stations (and other hardware) in one or more towers indicated by the triangles labeled “304(x).” In this example, each base station of the carrier networks 302, 304 provides three network sectors 106 for the sake of readability and convenience. However, base stations of the carrier networks 302, 304 can provide less than three (e.g., one or two) or more than three (e.g., four, five, ten or more) network sectors 106 arranged in any orientation, including network sectors 106 that can partially or fully overlap.

In the example shown, the coverage areas of the network sectors 332 and 336 of the second carrier network 304 overlap with the coverage area of 312 of the first carrier network 302. While the other coverage areas corresponding to the network sectors 106 of the carrier networks 302, 304 are mostly separate for clarity, it is understood that the carrier networks 302, 304 can provide coverage areas using the network sectors 106 that have significant overlap. In the example shown, some of the network sectors 106 of the second carrier network 304 overlap with one another. Other network sectors are shown as distinct for clarity of the figure. While the network sector 322 of the second carrier network 304 is shown as distinct from the network sectors 324 and 326, the border between the coverage areas can overlap in practice.

In various embodiments, the endpoint device 108 can acquire network performance data 120 and/or sector signal strengths 232 for one or more of the network sectors 312-326, 332-346 within the networked environment 300. In some embodiments, the endpoint device 108 acquires the network performance data 120 and/or the signal strengths 232 directly. For example, the connectivity management service 110 can cause the endpoint device 108 to perform a field test and acquire the signal strengths 232 for the network sectors 312-336, 332-356 based on the location within the networked environment 300. In such instances, the endpoint device 108 can store the acquired data as endpoint-acquired data 122 and/or signal strengths 232 for a defined duration (e.g., one week). In another example, the connectivity management service 110 can determine the available sector capacity for a given network sector based on the times that the endpoint device receives response messages. In such instances, the connectivity management service 110 can determine a sector latency value based on an aggregate, average, time it takes the connectivity management service 110 to receive the responses from one or more neighboring endpoints 108. In some embodiments, the connectivity management service 110 can also determine other network performance data 120, such as the failure rate for the reporting process, disconnection rates, signal strengths, and so forth.

In various embodiments, the endpoint device 108 can acquire network performance data 120 from one or more neighboring endpoint devices 340, 350 and/or the back office 102. For example, the connectivity management service 110 can cause the endpoint device 108 to transmit requests to one or more neighboring endpoint devices 340, 350 and can receive one or more sets of neighbor report data 124. Additionally or alternatively, the endpoint device 108 can transmit a request to the back office 102, whereupon the back office 102 can transmit the back office data 126. In some embodiments, the back office 102 filters the data included in the back office data 126. For example, the back office 102 can store deployment information and measurement data acquired by endpoint devices 108 within the geographic region and other geographic regions. In such instances, the back office 102 can filter the data to include in the back office data 126 to data that is relevant to geographic region where the endpoint device 108 is located. In various embodiments, the endpoint device 108 requests and receives the network report data 124 and/or the back office data 126 over a different connection than the connection established between the endpoint device 108 and the current network sector.

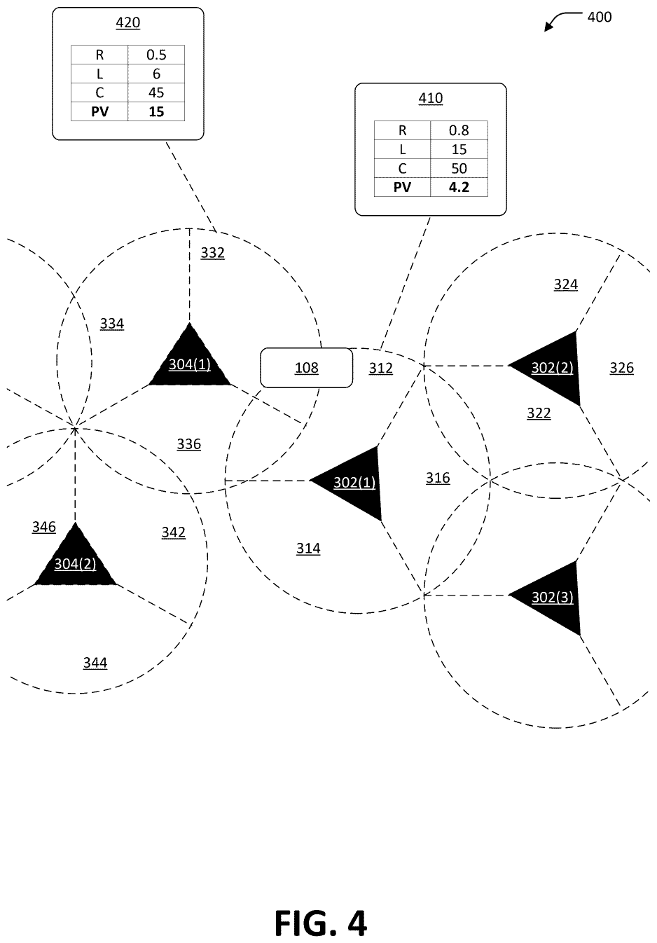

FIG. 4 illustrates another example of the connectivity management service 110 of FIG. 1 selecting a sector for connection based on performance data for a plurality of sectors, according to various embodiments. As shown, the networked environment 400 includes, without limitation, the first carrier network 302, the second carrier network 304, and the endpoint device 108. The carrier network 302 includes without limitation, network sectors 312, 314, 316, 322, 324, 326. The carrier network 304 includes, without limitation, network sectors 332, 334, 336, 342, 344, 346. The network sector 312 has corresponding connectivity performance metrics 410. The network sector 332 has corresponding connectivity performance metrics 420.

In operation, the connectivity management service 110 computes connectivity performance metrics 130 for a plurality of carrier networks 104, towers, and/or network sectors 106. In such instances, the connectivity management service 110 processes the connectivity performance metrics 130 to determine whether to maintain the current connection or disconnect and attempt a new connection with a different carrier network 104, tower, and/or network sector 106. As shown, the connectivity management service 110 compares the connectivity performance metrics 420 for the network sector 332 with the connectivity performance metrics 410 for the network sector 312 to determine whether to maintain a connection with the network sector 312 or disconnect an establish a connection with the network sector 332.

In various embodiments, the connectivity management service 110 processes the neighbor report data 124 acquired from the neighboring endpoint devices 340, 350 and/or the back office data 126 to determine latency data 222, capacity data 224, and/or reliability data 226 for the network sectors 312-326, 332-346. The connectivity management service 110 then uses the latency data 222, the capacity data 224, and/or the reliability data 226 to compute performance values for the network sectors 312-326, 332-346. The connectivity management service 110 can then compare the performance values of the network sectors 312-326, 332-346.

For example, the connectivity management service 110 can extract the latency data 222, capacity data 224, and reliability data 226 for the network sector 332 and determine a set of connectivity performance metrics 420. These connectivity performance metrics include specific values for reliability (R=0.5), latency (L=6) and capacity (C=45). The connectivity management service 110 can then compute the performance value as a combination of the reliability, latency, and capacity values (PV=15). Similarly, the connectivity management service 110 can extract the latency data 222, capacity data 224, and reliability data 226 for the network sector 312 and determine a set of connectivity performance metrics 410. These values include specific values for reliability (R=0.8), latency (L=15) and capacity (C=50). The connectivity management service 110 can then compute the performance value as a combination of the reliability, latency, and capacity values (PV=4.2). Upon determining that the network sector 332 possesses a higher performance value than the network sector 312, the connectivity management service 110 determines that the endpoint device 108 is to disconnect from the network sector 312 and is to attempt a connection with the network sector 332.

After deciding to switch to a new network sector 332, the connectivity management service 110 can cause the transceivers 206 to switch from operating using a first directional antenna pattern 234 (e.g., the directional antenna pattern 234(1)) to using a different directional antenna pattern 234 (e.g., the directional antenna pattern 234(2)). As a result of the change in the directional antenna pattern 234, the signal strengths 232 for the network sectors 312-326, 332-346 change. The endpoint device 108 can then acquire a subsequent set of signal strengths 232 the network sectors 312-326, 332-346. The connectivity management service 110 can refer to the subsequent set of signal strengths 232 to determine whether the signal strength for the network sector 332 exceeds the sector signal strengths of the other network sectors 314-326 and 332-346. When the subsequent signal strengths 232 indicate that the signal strength 232 of the network sector 332 exceeds the other signal strengths 232, the modem 218 selects the network sector 332 for connection based on the default connection criteria. When the subsequent set of signal strengths 232 indicate that at least one other network sector (e.g., the network sector 336) has a signal strength 232 exceeding the signal strength 232 of the network sector 332, the connectivity management service 110 can cause the transceivers 206 to operate using another directional antenna pattern 234 (e.g., the directional antenna pattern 234(3)). In such instances, the connectivity management service 110 can iteratively select new directional antenna patterns 234 until the network sector 332 exhibits the highest signal strength 232.

In some embodiments, the connectivity management service 110 can test the connection for the new network sector 332. For example, the connectivity management service 110 can perform a field test to acquire new network performance data 120 based on the connection to the new network sector 332. The connectivity management service 110 can then determine one or more connectivity performance metrics 130 corresponding to the new network sector 332. In such instances, the connectivity management service 110 can compare the network performance metrics 130 to one or more defined thresholds (e.g., a latency threshold, a capacity threshold, a performance value threshold, etc.) and can revert to the connection to the previous network sector 332 when the network performance metrics 130 do not meet the one or more defined thresholds.

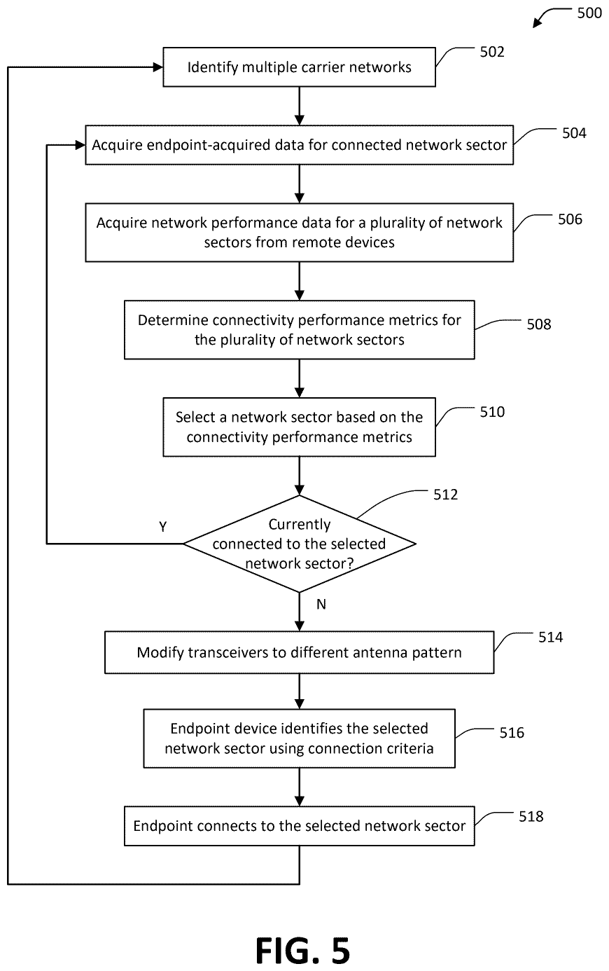

FIG. 5 illustrates a flow diagram of method steps for the multi-carrier connectivity management service to select a network based on network performance data, according to various embodiments. Although the method steps are shown in an order, persons skilled in the art will understand that some method steps may be performed in a different order, repeated, omitted, and/or performed by components other than those described in FIG. 5. Although the method steps are described with respect to the systems of FIGS. 1-4, persons skilled in the art will understand that any system configured to perform the method steps, in any order, falls within the scope of the various embodiments.

As shown, a method 500 begins at step 502, where an endpoint device 108 identifies multiple carrier networks 104. In various embodiments, a connectivity management service 110 included in the endpoint device 108 detects and identifies one or more carrier networks 104 in an environment. In some embodiments, the connectivity management service 110 performs a discovery process to identify one or more carrier networks 104. In such instances, the connectivity management service 110 scan the networked environment 100 and identify one or more network sectors 106 for each identified carrier network 104. For example, the connectivity management service 110 can identify multiple carrier networks 104 (e.g., the carrier networks 302, 304). The connectivity management service 110 can also identify multiple network sectors 106 for a given carrier network 104 (e.g., the network sectors 312-316 for the carrier network 302). Additionally or alternatively, the connectivity management service 110 can identify a set of carrier networks 104 that are supported by a multi-carrier SIM. For example, the connectivity management service 110 can retrieve a data record from the memory 210. In such instances, the data record can include a set of carrier identifiers corresponding to the set of carrier networks 104 supported by the multi-carrier SIM.

At step 504, the connectivity management service 110 acquires endpoint-acquired data 122 for the connected network sector 106. In various embodiments, the connectivity management service 110 can acquire the network performance data 120 that is acquired by the endpoint device 108. The endpoint device 108 can observe, measure, and or directly calculates various data about a plurality of network sectors 106 and include the data in the endpoint-acquired data 122. The endpoint-acquired data 122 can include measurements, such as latency measurements, reliability measurements, and signal strengths. The endpoint-acquired data 122 can also include carrier data, such as carrier-specific data records.

At step 506, the connectivity management service 110 acquires network performance data 120 for a plurality of network sectors from one or more remote devices. In various embodiments, the connectivity management service 110 can cause the endpoint device 108 to receive report data from one or more remote devices, such as managing devices of the carrier networks 104, neighboring endpoint devices 108, the back office 102, and so forth. For example, the endpoint device 108 can periodically request neighbor report data 124 from each neighboring endpoint device 108. The endpoint device 108 can also request back office data 126 from the back office 102. In some examples, different devices provide several types of network performance data 120 including different parameters, different sets of parameters, and/or data different formats. In various embodiments, the network performance data 120 included in the respective neighbor report data 124 and/or the back office data 126 includes network-level performance information for a particular carrier network 104 and/or region-level performance information specific to a region where the endpoint device 108 is located.

At step 508, the endpoint device 108 determines connectivity performance metrics 130 for the network sectors 106. In various embodiments, the connectivity management service 110 can compute one or more connectivity performance metrics 130 for one or more of the identified network sectors 106. The connectivity management service 110 can compute connectivity performance metrics 130 for the plurality of network sectors 106 by extracting data for each network sector 106 from the endpoint-acquired data 122, the neighbor report data 124, and the back office data 126. For example, the connectivity management service 110 can extract latency data 222, capacity data 224, and reliability data 226 for each of the plurality of identified network sectors 106. The connectivity management service 110 can then compute a performance value (PV) as a weighted sum of latency (L), capacity (C), and reliability (R) values (e.g., equation 1) that represent latency data 222, capacity data 224, and reliability data 226. In some embodiments, the connectivity management service 110 computes the performance value as a ratio of the latency, capacity, and reliability values (e.g., equation 2). Alternatively, in some embodiments, the performance value is further based on a set of signal strengths 232 (e.g., equation 3).

At step 510, the endpoint device 108 selects a network sector 106 based on the connectivity performance metrics 130. In various embodiments, the connectivity management service 110 uses the connectivity performance metrics 130 to select a specific carrier network 104 and/or select a specific network sector 106 (e.g., the network sector 312) with which the endpoint device 108 is to establish a connection. For example, the connectivity management service 110 can order the network sectors 312-326, 332-346 based on the corresponding computed performance values and select the highest-ranked network sector 312. In some embodiments, the connectivity management service 110 selects a network sector 106 based on a set of rules. For example, the connectivity management service 110 can adhere to a rule specifying that 5% of endpoint devices 108 observing RRC latencies of at least one minute connected to a first network sector 106(1) with neighboring endpoints 108 on alternate network sectors 106(2)-106(3) that observe RRC obtain latencies below 30 seconds shall migrate after 12 hours of observing this condition. In such instances, the connectivity management service 110 can apply a randomness factor to the performance metrics based on the amount of endpoint devices 108 that are to switch to reflect the probability of switching upon observing the condition.

At step 512, the endpoint device 108 determines whether a connection is already established with the selected network sector 106. In various embodiments, the connectivity management service 110 determines whether the endpoint device 108 has an existing connection with the selected network sector 312. For example, the connectivity management service 110 can periodically compute the connectivity performance metrics 130. When the connectivity management service 110 determines that the network sector with which the endpoint device 108 has existing connection is ranked highest, the connectivity management service 110 can refrain from switching to a different network sector (e.g., the endpoint device 108 has a connection to the network sector 312). When the connectivity management service 110 determines that a connection is already established with the selected network sector 312, the connectivity management service 110 returns to step 504 to acquire network performance data 120 at a subsequent time (e.g., wait for a defined period before acquiring the network performance data 120). Otherwise, the connectivity management service 110 determines that the endpoint device 108 does not have an established connection with the selected network sector 312 and proceeds to step 512.

At step 514, the endpoint device 108 adjusts the transceivers 206 to the identified directional antenna pattern 234. In various embodiments, the connectivity management service 110 can cause the endpoint device 108 to store a plurality of directional antenna patterns 234 and/or a set of sector signal strengths 232. In such instances, the endpoint device 108 can identify a specific directional antenna pattern 234 where the signal strength of the selected network sector 312 is expected to be higher than the signal strength for other network sectors 314, 316, 322-326. The connectivity management service 110 can then adjust the transceivers 206 of the endpoint device 108 via the wireless controller 214 to operate using the identified directional antenna pattern 234. For example, the transceivers 206 can form a phased array that receives a feed current controlled by the wireless controller 214. In such instances, the connectivity management service 110 can transmit a command to the wireless controller 214 to operate using the selected directional antenna pattern 234. The wireless controller 214 can respond to the command by using one or more phase shifters and/or other hardware to control the transceivers 206 to operate using the selected directional antenna pattern 234.

At step 516, the endpoint device 108 identifies the selected network sector 312 for connection using connection criteria. In various embodiments, the modem 218 included in the endpoint device 108 selects a network sector 106 for selection based on connection criteria. In various embodiments, the connection criteria can be a default type, such as the relative signal strengths of the network sectors 106. In such instances, the previous change by the endpoint device 108 to using the directional antenna pattern 234 causes the selected network sector 312 to exhibit a higher signal strength relative to the sector signal strengths 232 of other network sectors 314-316, 322-326. In such instances, the modem 218 uses the default connection criteria to rank the network sector 312 highest among the network sectors 312-326, 332-346 and causes the network sector 312 to be used for connection.

At step 518, the endpoint device 108 connects to the selected network sector 312. In various embodiments, the modem 218 of the endpoint device 108 controls the establishment of a communication channel to the access point of the selected network sector 106, whereupon the endpoint device 108 is connected to the selected network sector 312.

In sum, techniques are disclosed herein for providing a connectivity management service that selects a network sector for connection and causes the endpoint device to control a connection to the selected network sector. According to various embodiments, the connectivity management service executing on the endpoint device generates performance metrics relating to the reliability, latency, and capacity of a plurality of network sectors. The endpoint device initially performs direct measurements of latency values, reliability values, and capacity values of a specific network sector to which the endpoint device is connected. The endpoint device also communicates with neighboring endpoint devices that share report data. Further, the endpoint device acquires data from a back office, where the back office data includes deployment information associated with a plurality of endpoints included in a geographic region. The connectivity management service processes the direct measurements to determine a set of connectivity performance metrics for a specific network sector. The connectivity management service also processes the report data and the back office data to generate additional connectivity performance metrics for a plurality of network sectors.

The connectivity management service uses the connectivity performance metrics and the additional connectivity performance metrics to determine whether the endpoint device is to stay connected to the specific network sector or select a second network sector for a network connection. The determination can be based on a weighted combination of performance metrics, including weighted latency values, weighted reliability values, and weighted capacity values. When the connectivity management service determines to disconnect from the specific network sector and selects the second network sector, the connectivity management service performs actions that cause the endpoint device to select the second network sector for connection. In some instances, the connectivity management service adjusts one or more transceivers of the endpoint device to operate using an updated antenna pattern. When the endpoint device uses the updated antenna pattern, the second network sector has a signal strength that is higher than the signal strengths of other network sectors. Due to the second network sector exhibiting the highest signal strength, a modem of the endpoint device selects the second network sector for connection and establishes a connection to the second network sector.

At least one technical advantage of the disclosed techniques is that the disclosed techniques increase the connectivity of endpoint devices deployed in an environment, increasing the reliability of connections via carrier networks. In particular, by enabling endpoint devices to analyze network performance data, the endpoint device can determine which carrier networks, and which network sectors provide the best combination of network reliability, capacity and latency. Further, the disclosed techniques reduce disconnection rates and power usage of an endpoint device while balancing available capacity across multiple sectors. These technical advantages represent one or more technological improvements over prior art approaches.
1. In various embodiments, a method comprises acquiring, by a connectivity management service executing on an endpoint device, performance metrics for a plurality of network sectors, where the performance metrics include at least one of a latency, a capacity, or packet reliability, selecting, by the connectivity management service and based at least on the performance metrics and additional performance metrics, a first network sector of the plurality of network sectors, and causing, by the connectivity management service, the endpoint device to connect to the first network sector.
2. The method of clause 1, further comprising receiving, by the endpoint device, the additional performance metrics from a remote device, where the remote device comprises a neighboring endpoint device or a server included in a back office.
3. The method of clause 1 or 2, where the additional performance metrics include report data from a neighboring endpoint device, and the report data includes at least one of a device type or an anticipated data load.
4. The method of any of clauses 1-3, where the additional performance metrics include report data from a server included in a back office, and the report data includes at least one of: a total number of endpoint devices, a percentage of successful interrogation responses, or an average latency.
5. The method of any of clauses 1-4, where the performance metrics for the plurality of network sectors includes at least one of: a metric for performance reliability, a metric for loading, a metric for latency of carriers in a geographic area, a radio resource control (RRC) connection latency, a dynamic latency, a number of connectivity or communication failures, a time to register, a time of connection loss, a number of repetitions for sending or receiving a packet, or a data rate.
6. The method of any of clauses 1-5, where selecting the first network sector is further based on signal strengths for the plurality of network sectors.
7. The method of any of clauses 1-6, further comprising receiving, by the connectivity management service, connection information acquired by the endpoint device, where the connection information identifies at least one of a network sector, tower, or carrier network to which the endpoint device currently connected.
8. The method of any of clauses 1-7, where the performance metrics for the plurality of network sectors are based on one or more weighted sums of respective latency values, respective capacity values, or reliability values for the plurality of network sectors.
9. The method of any of clauses 1-8, further comprising computing, for the respective carrier networks of the plurality of carrier networks, a respective performance value, where the performance value is based on the performance metrics and the additional performance metrics, and where selecting the first network sector is based on the first network sector having a highest performance value among a plurality of performance values.
10. The method of any of clauses 1-9, further comprising computing, for the respective carrier networks of the plurality of carrier networks, a respective performance value, where the performance value is based on the performance metrics and the additional performance metrics, applying one or more randomness factors to the respective performance values to generate respective random performance values, where selecting the first network sector is based on the first network sector having a highest random performance value among a plurality of random performance values.
11. The method of any of clauses 1-10, further comprising upon disconnecting from the first network sector, selecting, by the connectivity management service, a second network sector of the plurality of network sectors, where the second network sector corresponds to a second carrier network, and causing, by the connectivity management service, the endpoint device to connect to the second network sector.
12. In various embodiments, one or more non-transitory computer-readable media storing instructions which, when executed by one or more processors of a node in a network, cause the one or more processors to perform operations comprising determining performance values for a plurality of network sectors, where the performance values include at least one of a latency, a capacity, or packet reliability, acquiring report data from one or more remote devices, determining additional performance values from the report data, identifying, by a connectivity management service and based at least on the performance values and the additional performance values, a first network sector of the plurality of network sectors for a network connection, and causing, by the connectivity management service, the node to establish the network connection to the first network sector.
13. The one or more non-transitory computer-readable media of clause 12, where the additional performance values include report data from a neighboring endpoint device or from a server included in a back office, and the report data includes at least one of: a device type or an anticipated data load, a total number of endpoint devices, a percentage of successful interrogation responses, or an average latency.
14. The one or more non-transitory computer-readable media of clause 12 or 13, where the performance values for the plurality of network sectors includes at least one of a metric for performance reliability, a metric for loading, a metric for latency of carriers in a geographic area, a radio resource control (RRC) connection latency, a dynamic latency, a number of connectivity or communication failures, a time to register, a time of connection loss, a number of repetitions for sending or receiving a packet, or a data rate.
15. The one or more non-transitory computer-readable media of any of clauses 12-14, the operations further comprising computing, for the respective carrier networks of the plurality of carrier networks, a respective performance value, where the performance value is based on the performance metrics and the additional performance metrics, and where selecting the first network sector is based on the first network sector having a highest performance value among a plurality of performance values.
16. The one or more non-transitory computer-readable media of any of clauses 12-15, the operations further comprising computing, for the respective carrier networks of the plurality of carrier networks, a respective performance value, where the performance value is based on the performance metrics and the additional performance metrics, applying one or more randomness factors to the respective performance values to generate respective random performance values, where selecting the first network sector is based on the first network sector having a highest random performance value among a plurality of random performance values.
17. In various embodiments, a computing system comprises one or more processors, one or more transceivers, and a memory storing executable instructions which, when executed by the one or more processors, cause the one or more processors to perform operations comprising measuring one or more network measurements for a plurality of network sectors, where the one or more network measurements includes measurements corresponding to least one of a latency, a capacity, or packet reliability for at least one of the plurality of network sectors, selecting, by a connectivity management service and based at least on the network measurements and additional network information received from a second device, a first network sector of the plurality of network sectors, and causing the transceiver to connect to the first network sector by configuring the transceiver so that a signal strength of the first network sector is a highest signal strength among the plurality of network sectors.
18. The computer system of clause 17, where the additional network information includes report data from a neighboring endpoint device or a server, and the report data includes at least one of: a device type or an anticipated data load, a total number of endpoint devices, a percentage of successful interrogation responses, or an average latency.
19. The computer system of clause 17 or 18, where the network measurements for the plurality of network sectors are based on one or more weighted sums of respective latency values, respective capacity values, or reliability values for the plurality of network sectors.
20. The computer system of any of clauses 17-19, where the operations further comprise scanning for respective sectors with which the computer system is able to connect, where the plurality of network sectors includes the respective sectors with which the computer system is able to connect.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method comprising:
acquiring, by a connectivity management service executing on an endpoint device, performance metrics for a plurality of network sectors, wherein the performance metrics include at least one of a latency, a capacity, or packet reliability;
selecting, by the connectivity management service and based at least on the performance metrics and additional performance metrics, a first network sector of the plurality of network sectors; and
causing, by the connectivity management service, the endpoint device to connect to the first network sector.

2. The method of claim 1, further comprising:
receiving, by the endpoint device, the additional performance metrics from a remote device,
wherein the remote device comprises a neighboring endpoint device or a server included in a back office.

3. The method of claim 1, wherein:
the additional performance metrics include report data from a neighboring endpoint device; and
the report data includes at least one of a device type or an anticipated data load.

4. The method of claim 1, wherein:
the additional performance metrics include report data from a server included in a back office; and
the report data includes at least one of: a total number of endpoint devices, a percentage of successful interrogation responses, or an average latency.

5. The method of claim 1, wherein the performance metrics for the plurality of network sectors includes at least one of: a metric for performance reliability, a metric for loading, a metric for latency of carriers in a geographic area, a radio resource control (RRC) connection latency, a dynamic latency, a number of connectivity or communication failures, a time to register, a time of connection loss, a number of repetitions for sending or receiving a packet, or a data rate.

6. The method of claim 1, wherein selecting the first network sector is further based on signal strengths for the plurality of network sectors.

7. The method of claim 1, further comprising:
receiving, by the connectivity management service, connection information acquired by the endpoint device,
wherein the connection information identifies at least one of a network sector, tower, or carrier network to which the endpoint device currently connected.

8. The method of claim 1, wherein the performance metrics for the plurality of network sectors are based on one or more weighted sums of respective latency values, respective capacity values, or reliability values for the plurality of network sectors.

9. The method of claim 1, further comprising:
computing, for the respective carrier networks of the plurality of carrier networks, a respective performance value,
wherein the performance value is based on the performance metrics and the additional performance metrics, and
wherein selecting the first network sector is based on the first network sector having a highest performance value among a plurality of performance values.

10. The method of claim 1, further comprising:
computing, for the respective carrier networks of the plurality of carrier networks, a respective performance value, wherein the performance value is based on the performance metrics and the additional performance metrics,
applying one or more randomness factors to the respective performance values to generate respective random performance values, wherein selecting the first network sector is based on the first network sector having a highest random performance value among a plurality of random performance values.

11. The method of claim 10, further comprising:
upon disconnecting from the first network sector, selecting, by the connectivity management service, a second network sector of the plurality of network sectors, wherein the second network sector corresponds to a second carrier network; and
causing, by the connectivity management service, the endpoint device to connect to the second network sector.

12. One or more non-transitory computer-readable media storing instructions which, when executed by one or more processors of a node in a network, cause the one or more processors to perform operations comprising:
determining performance values for a plurality of network sectors, wherein the performance values include at least one of a latency, a capacity, or packet reliability;
acquiring report data from one or more remote devices;
determining additional performance values from the report data;
identifying, by a connectivity management service and based at least on the performance values and the additional performance values, a first network sector of the plurality of network sectors for a network connection; and
causing, by the connectivity management service, the node to establish the network connection to the first network sector.

13. The one or more non-transitory computer-readable media of claim 12, wherein:
the additional performance values include report data from a neighboring endpoint device or from a server included in a back office; and
the report data includes at least one of: a device type or an anticipated data load, a total number of endpoint devices, a percentage of successful interrogation responses, or an average latency.

14. The one or more non-transitory computer-readable media of claim 12, wherein the performance values for the plurality of network sectors includes at least one of: a metric for performance reliability, a metric for loading, a metric for latency of carriers in a geographic area, a radio resource control (RRC) connection latency, a dynamic latency, a number of connectivity or communication failures, a time to register, a time of connection loss, a number of repetitions for sending or receiving a packet, or a data rate.

15. The one or more non-transitory computer-readable media of claim 12, the operations further comprising:
computing, for the respective carrier networks of the plurality of carrier networks, a respective performance value,
wherein the performance value is based on the performance metrics and the additional performance metrics, and
wherein selecting the first network sector is based on the first network sector having a highest performance value among a plurality of performance values.

16. The one or more non-transitory computer-readable media of claim 12, the operations further comprising:
computing, for the respective carrier networks of the plurality of carrier networks, a respective performance value, wherein the performance value is based on the performance metrics and the additional performance metrics,
applying one or more randomness factors to the respective performance values to generate respective random performance values, wherein selecting the first network sector is based on the first network sector having a highest random performance value among a plurality of random performance values.

17. A computing system, comprising:
one or more processors;
one or more transceivers; and
a memory storing executable instructions which, when executed by the one or more processors, cause the one or more processors to perform operations comprising:
measuring one or more network measurements for a plurality of network sectors, wherein the one or more network measurements includes measurements corresponding to least one of a latency, a capacity, or packet reliability for at least one of the plurality of network sectors;
selecting, by a connectivity management service and based at least on the network measurements and additional network information received from a second device, a first network sector of the plurality of network sectors; and
causing the transceiver to connect to the first network sector by configuring the transceiver so that a signal strength of the first network sector is a highest signal strength among the plurality of network sectors.

18. The computer system of claim 17, wherein:
the additional network information includes report data from a neighboring endpoint device or a server; and
the report data includes at least one of: a device type or an anticipated data load, a total number of endpoint devices, a percentage of successful interrogation responses, or an average latency.

19. The computer system of claim 17, wherein the network measurements for the plurality of network sectors are based on one or more weighted sums of respective latency values, respective capacity values, or reliability values for the plurality of network sectors.

20. The computer system of claim 17, wherein the operations further comprise scanning for respective sectors with which the computer system is able to connect, wherein the plurality of network sectors includes the respective sectors with which the computer system is able to connect.
